(19) United States
(12) Patent Application Publication
(10) Pub. No.: US 2025/0278846 A1
(43) Pub. Date: Sep. 4, 2025

(54) VEHICLE SEAT FORCE TRACKING SYSTEM

(71) Applicant: Toyota Research Institute, Inc., Los Altos, CA (US)

(72) Inventors: Vitor Campagnolo Guizilini, Santa Clara, CA (US); Erin A. McColl, Los Gatos, CA (US); Edwardo Martinez, Fremont, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/592,749

(22) Filed: Mar. 1, 2024

(51) Int. Cl. G06T 7/50; G06V 20/59; G06V 40/10

(52) U.S. Cl. CPC G06T 7/50; G06V 20/593; G06V 40/10; G06T 2207/10028; G06T 2207/30196; G06T 2207/30268

(57) ABSTRACT

Systems and methods described herein relate to implementing measuring vehicle seat forces. In one embodiment, a method includes obtaining an image of a seat pattern attached to a seat, generating a depth map based on the image of the seat pattern, and assessing the depth map to determine a characteristic of an object residing on the seat.

### TECHNICAL FIELD

The subject matter described herein relates, in general, to strategies for measuring forces on a vehicle seat, and, more particularly, to using depth maps generated from a monocular camera to estimate forces on a vehicle seat.

### BACKGROUND

Vehicles may use pressure sensors to determine the presence of a vehicle occupant in a vehicle seat. For example, pressure sensors may be distributed throughout a seat to evaluate forces exerted by a vehicle operator as the vehicle is in motion.

### SUMMARY

In one embodiment, a compensation measure system is disclosed. The vehicle management system includes one or more processors and a memory communicably coupled to the one or more processors. The memory stores a command module including instructions that when executed by the one or more processors cause the one or more processors to obtain an image of a seat pattern attached to a seat, generate a depth map based on the image of the seat pattern, and assess the depth map to determine a characteristic of an object residing on the seat.

In one embodiment, a non-transitory computer-readable medium including instructions that when executed by one or more processors cause the one or more processors to perform one or more functions is disclosed. The instructions include instructions to obtain an image of a seat pattern attached to a seat, generate a depth map based on the image of the seat pattern, and assess the depth map to determine a characteristic of an object residing on the seat.

In one embodiment, a method for measuring forces on a vehicle seat is disclosed. In one embodiment, the method includes obtaining an image of a seat pattern attached to a seat, generating a depth map based on the image of the seat pattern, and assessing the depth map to determine a characteristic of an object residing on the seat.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a compensation measure system that is associated with measuring forces on a vehicle seat.

FIG. 3 illustrates one embodiment of a vehicle seat system for measuring seat forces.

FIG. 4 illustrates one example of a seat pattern.

FIG. 5 illustrates one example of a seat pattern deforming due to a force exerted on the seat.

FIG. 6 illustrates one example of obtaining depth images from monocular images.

FIG. 7 illustrates one example of an encoder/decoder architecture for obtaining depth images from monocular images.

FIG. 8 illustrates one example of obtaining a point cloud.

FIG. 9 illustrates one example of obtaining a force map.

FIG. 10 illustrates one example of a method for measuring seat forces.

### DETAILED DESCRIPTION

Systems, methods, and other embodiments associated with measuring forces on a vehicle seat are described herein. Rather than rely on pressure sensors to evaluate the forces that a vehicle occupant imposes on a vehicle seat, a seat pattern may be placed on the bottom of the vehicle seat and observed by a camera. Images from the camera may be used to construct a depth map, which may further be used to generate a point-cloud representation of the deformation pattern observed in the area of the seat pattern. In addition, force maps indicating the extent of changes in the deformation maps may be generated by comparing common features between point-clouds.

Given such depth maps, point-clouds, or force maps, the methods and systems herein may evaluate deformation patterns observed within the seat pattern. For example, different deformation patterns may indicate whether a person or a box is present in the seat. In addition, changes in deformation patterns may also be analyzed to determine if an object is in a high state of acceleration.

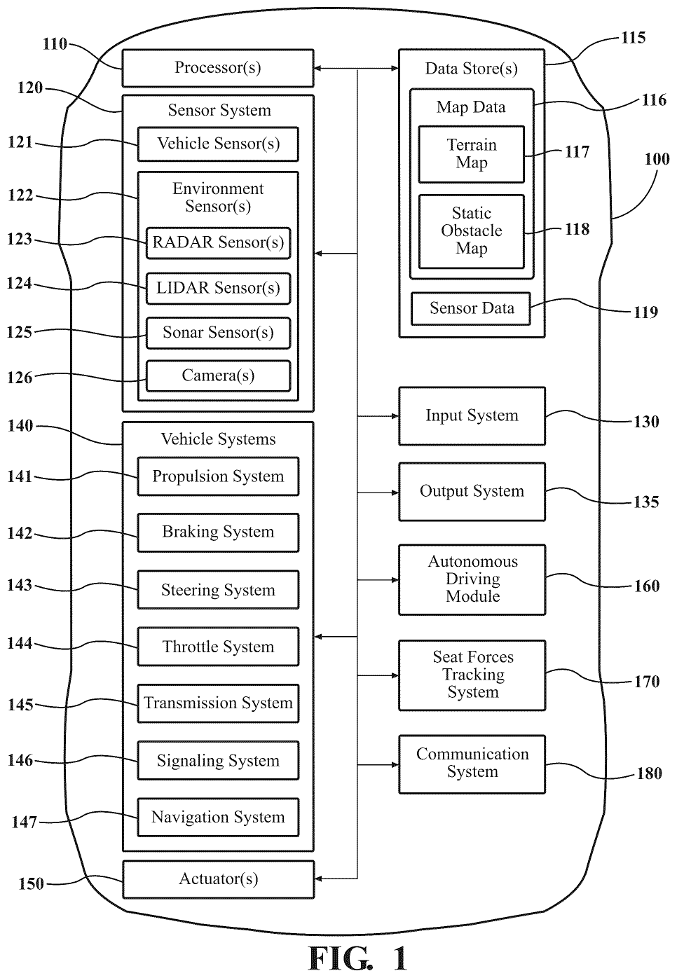

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with strategies for measuring seat forces. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

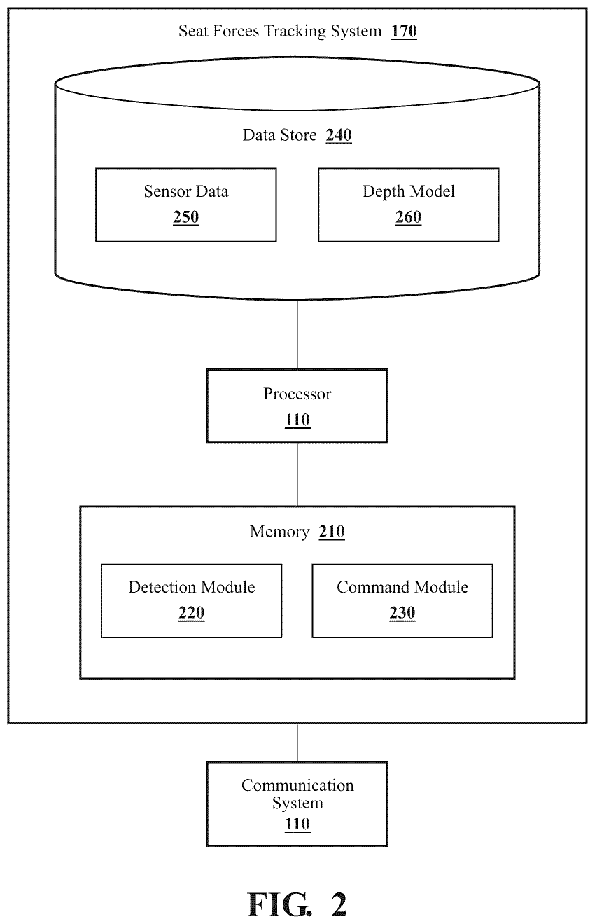

Some of the possible elements of vehicle 100 are shown in FIG. 1 and will be described along with subsequent figures. However, a description of many of the elements in FIG. I will be provided after the discussion of FIGS. 2-10 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a vehicle seat force tracking system 170 that is implemented to perform methods and other functions as disclosed herein relating to implementing vehicle seat force tracking. As will be discussed in greater detail subsequently, vehicle seat force tracking system 170, in various embodiments, is implemented partially within vehicle 100 and as a cloud-based service. For example, in one approach, functionality associated with at least one module of vehicle seat force tracking system 170 is implemented within vehicle 100 while further functionality is implemented within a cloud-based computing system.

With reference to FIG. 2, one embodiment of vehicle seat force tracking system 170 of FIG. 1 is further illustrated. Vehicle seat force tracking system 170 is shown as including processor(s) 110 from vehicle 100 of FIG. 1. Accordingly, processor(s) 110 may be a part of vehicle seat force tracking system 170, vehicle seat force tracking system 170 may include a separate processor from processor 110 (s) of vehicle 100, or vehicle seat force tracking system 170 may access processor 110 (s) through a data bus or another communication path. In one embodiment, vehicle seat force tracking system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Vehicle seat force tracking system 170 as illustrated in FIG. 2 is generally an abstracted form of vehicle seat force tracking system 170 as may be implemented between vehicle 100 and a cloud-computing environment. Accordingly, vehicle seat force tracking system 170 may be embodied at least in part within a cloud-computing environment to perform the methods described herein.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allow for implementing vehicle seat force tracking.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, vehicle seat force tracking system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to generate depth maps or point clouds from images as described herein. In some embodiments, detection module 220 may receive and store depth maps or point clouds.

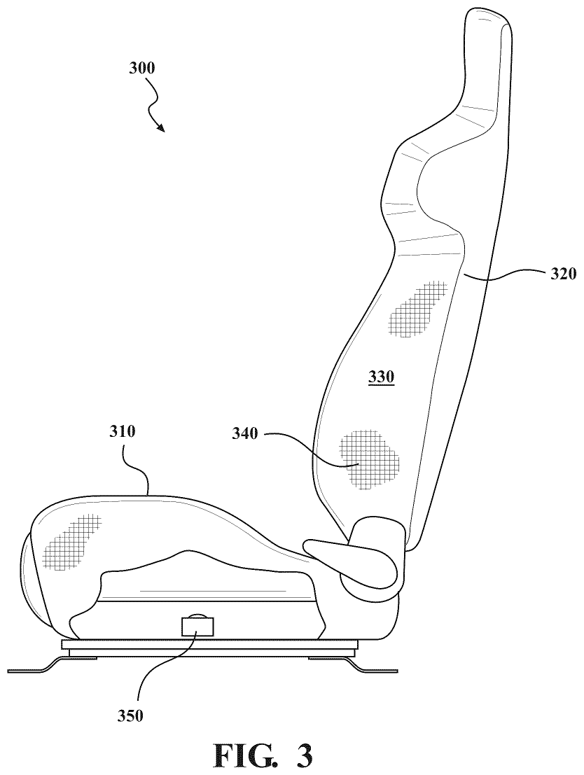

With respect to FIG. 3, an example of a vehicle seat system 300 is shown. Seat assembly 310 may be mounted within vehicle 100 to provide seating for a vehicle occupant (e.g., driver, passenger). Seat assembly 310 may be comprised of seat frame 320, seat material 330, scat pattern 340, and pattern camera 350.

Seat frame 320 may be constructed as a supporting structure for a vehicle seat, which may be made of materials such as steel, aluminum, wood (e.g., bamboo), carbon fiber reinforced plastic, glass fiber-reinforced semi-finished thermoplastic composite, etc. Seat frame 320 may also be comprised of multiple subframe components (e.g., a base frame, a back frame, a seat frame).

Scat material 330 may be constructed as a supporting material for a vehicle seat, which may be made of deformable materials such as foam, leather, cloth, plastics, and so on. In some embodiments, seat material 330 may further include rigid materials (e.g., a plastic panel mounted to the rear of a vehicle seat) that do not inhibit the movement of seat pattern 340 as described below.

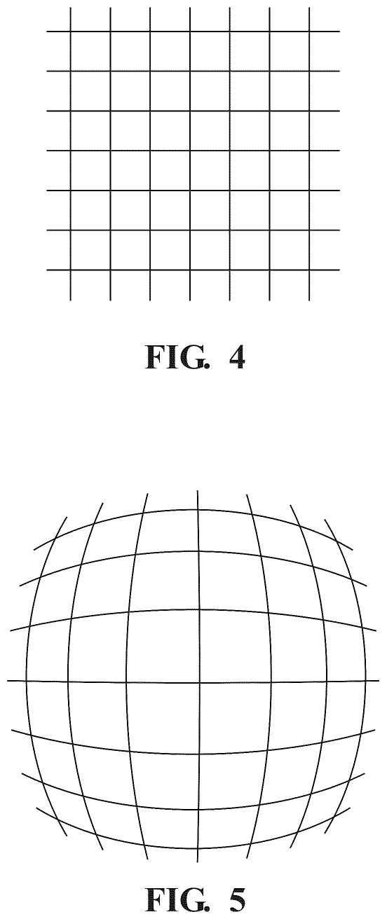

Seat pattern 340 may be constructed as a pattern attached to seat material 330 such that seat pattern 340 is able to reflect the deformation of seat material 330 within a pre-determined area. For example, in order to measure seat forces relative to a vehicle occupant, the seat portion of seat material 330 may be comprised of a deformable material (e.g., foam) that reflects the weight and movement of a person or object placed on the seat portion of seat material 330. In some embodiments, a seat pattern such as grid pattern 400 as shown in FIG. 4 may be attached to, printed on, or otherwise placed upon seat material 330. Accordingly, when the deformations arising from the weight or movement of a person or object placed on the seat portion of seat material 330 change, so too will the alterations in the deformations change the seat pattern 340 as if it were part of seat material 330. As shown in FIG. 5, seat pattern 340 may utilize grid pattern 400 to visually demonstrate differences in deformation. However, other visual arrangements suitable for tracking by a camera may also be used (e.g., a pattern of intersecting grid lines, a set of circles of increasing radii having a common center point). In some embodiments, illumination may be provided to improve visibility of seat pattern 340 to pattern camera 350.

Pattern camera 350 may be constructed as one or more cameras (e.g., a monocular camera, a calibrated pair of stereo cameras) that is positioned to observe seat pattern 340. In some embodiments, pattern camera 350 may be mounted or integrated into seat assembly 310 where it may observe the movements of seat pattern 340. In some embodiments, pattern camera 350 may be mounted or integrated into an area other than seat assembly 310, such as on the floor of vehicle 100 in a position that can observe seat pattern 340 of seat assembly 310. Pattern camera 350 may be used to capture images, which may be comprised of individual monocular images that encode visual data according to an imaging standard (e.g., codec) associated with pattern camera 350. In general, characteristics of a source camera (e.g., pattern camera 350) and the video standard may define a format for the monocular images. Thus, while the particular characteristics can vary according to different implementations, in general, the monocular images may have a defined resolution (i.e., height and width in pixels) and format. Thus, for example, the monocular image may generally be an RGB visible light image. In further aspects, the monocular image may be an infrared image associated with a corresponding infrared camera, a black/white image, or another suitable format as may be desired. Whichever format that may be implemented, when the image is a monocular image then there may be no explicit additional modality indicating depth nor any explicit corresponding image from another camera from which the depth can be derived (i.e., no stereo camera pair). As should be appreciated, pattern camera 350 may capture video that includes a series of monocular images that are taken in succession according to a configuration of pattern camera 350. Thus, pattern camera 350 may generate the images (also referred to herein as frames) of the video at regular intervals, such as every 0.033 s. That is, a shutter of the camera operates at a particular rate (i.e., frames-per-second (fps) configuration), which may be, for example, 24 fps, 30 fps, 60 fps, etc. For purposes of the present discussion, the fps is presumed to be 30 fps. However, it should be appreciated that the fps may vary according to a particular configuration.

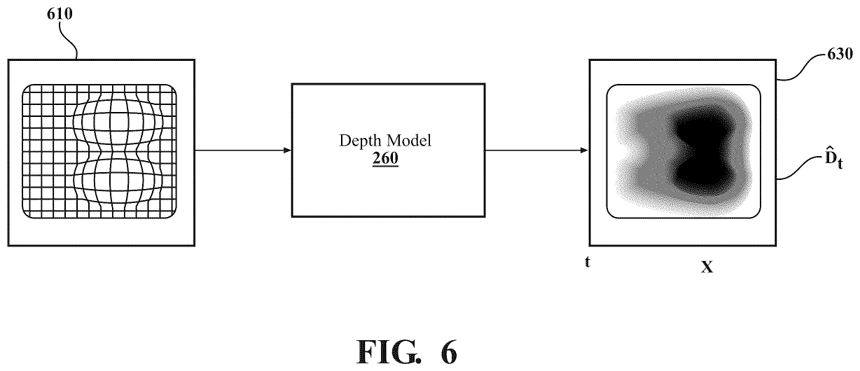

In some embodiments, command module 230 may include instructions to apply a depth model to a monocular image in order to generate a depth map. For instance, depth model 260, as illustrated in detail in FIG. 6, identifies an exemplary flow of a processing channel formed by the depth model 260 for processing monocular images. It should be appreciated that the depth model 260 is generally a machine learning algorithm that may be broadly characterized as a convolutional neural network (CNN) or as an encoder/decoder architecture, including convolutional and deconvolutional components.

As shown in FIG. 6, monocular image 610 may be provided as an input into the depth model 260. Depth model 260, in one embodiment, includes encoder 700 that may accept monocular image 610 as an electronic input and may process monocular image 610 to extract depth features. It should be appreciated that while depth model 260 is discussed as a separate, distinct component, in one or more approaches, depth model 260 may be integrated with command module 230. Thus, command module 230 may implement various routines/functions of depth model 260 while storing data values (e.g., weights) of depth model 260. In any case, the depth features are, in general, aspects of an image that are indicative of spatial information that is intrinsically encoded therein. One example of an architecture for the encoding layers that form encoder 700 may include a series of layers that function to fold (i.e., adapt dimensions of the feature map to retain the features) encoded features into separate channels iteratively reducing spatial dimensions of monocular image 610 while packing additional channels with information about embedded states of the features. The addition of the extra channels may avoid the lossy nature of the encoding process and facilitate the preservation of more information (e.g., feature details) about the original monocular image 610.

Accordingly, in at least one approach, encoder 700 is comprised of multiple encoding layers formed from a combination of two-dimensional (2D) convolutional layers, packing blocks, and residual blocks. While encoder 700 is presented as including the noted components, it should be appreciated that further embodiments may vary the particular form of the encoding layers (e.g., convolutional and pooling layers without packing layers), and thus the noted configuration is one example of how the vehicle seat force tracking system 170 may implement the depth model 260. The separate encoding layers generate outputs in the form of encoded feature maps (also referred to as tensors), which the encoding layers provide to subsequent layers in depth model 260, including specific layers of decoder 710 via skip connections that may function to provide residual information between the encoder 700 and the decoder 710. Thus, the encoder 700 includes a variety of separate layers that operate on the monocular image 610, and subsequently on derived/intermediate feature maps that convert the visual information of the monocular image 610 into embedded state information in the form of encoded features of different channels. In any case, the output of the encoder 700 is, in one approach, a feature map having a particular dimension (e.g., 512×H/32×W/32) that is transformed in relation to the image 410 (e.g., 3×H×W).

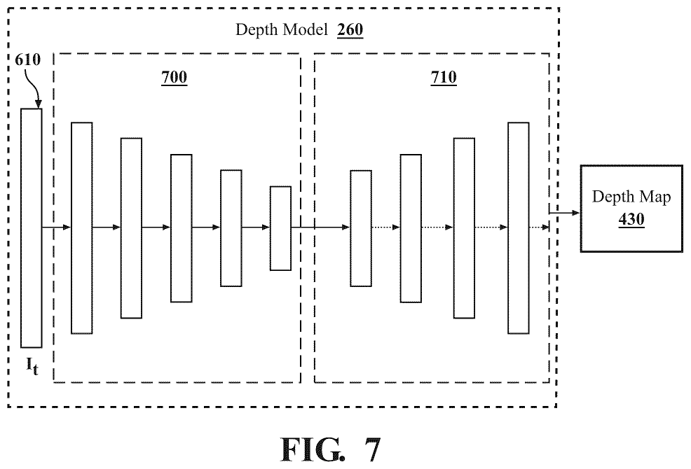

With continued reference to FIG. 7, the depth model 260 further includes the decoder 710. One example of how the decoder 710 functions includes unfolding (i.e., adapting dimensions of the tensor to extract the features) the previously encoded spatial information in order to derive depth map 630 according to learned correlations associated with the encoded features. That is, the decoding layers generally function to up-sample, through sub-pixel convolutions and other mechanisms, the previously encoded features into depth map 630. In one or more arrangements, the decoding layers comprise unpacking blocks, two-dimensional convolutional layers, and inverse depth layers that function as output layers for different scales. In further aspects, decoder 710 may also receive inputs via guiding connections from another model, such as identification of different instances within monocular image 610 from a semantic segmentation model that further guides determinations of the depths. While decoder 710 is presented as including the noted components, it should be appreciated that further arrangements may vary the particular form of the decoding layers (e.g., deconvolutional layers without unpacking layers), and thus the noted configuration is one example of how vehicle seat force tracking system 170 may implement decoder 710.

In any case, the vehicle seat force tracking system 170, in one embodiment, employs depth model 260 to produce depth map 630, which, in one or more arrangements, may be provided as an inverse mapping having inverse values for the depth estimates. In general, however, depth map 630 is a pixel-wise prediction of depths for monocular image 610. That is, the depth model 260 provides estimates of depths for different aspects depicted in the monocular image 610. It should be appreciated that, in one embodiment, the command module 230 generally includes instructions that function to control the processor 110 to execute various actions to control the depth model 260 to produce depth map 630.

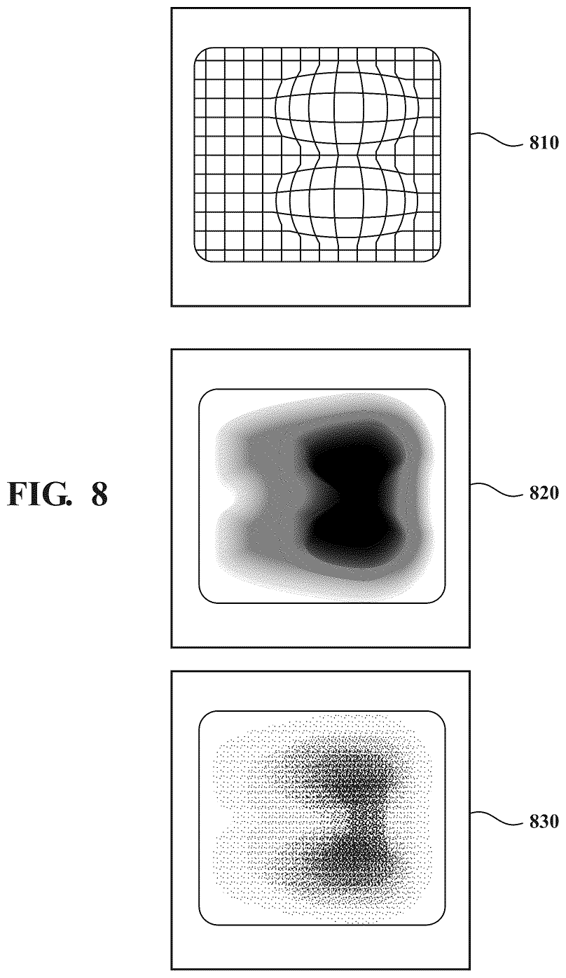

Command module 230, upon receiving a depth map, may generate a point-cloud. For example, command module 230 may use the RGB data of monocular image 610 and the depth date of depth map 630 to generate point cloud 650 based on camera intrinsics (e.g., focal length, optical center of camera, image size, radial lens distortion, tangential distortion coefficients, camera axes skew, camera intrinsic matric) of pattern camera 350. In at least one approach, command module 230 may generate such a point cloud 650 using a pinhole camera model, but it should be appreciated that further embodiments may vary the particular form of the modeling and thus the noted configuration is one example of how the vehicle seat force tracking system 170 may implement depth map to point-cloud conversion. For example, as shown in FIG. 8, information between monocular image 810 and depth map 820 may be used to generate point cloud 830 (e.g., via pinhole camera model).

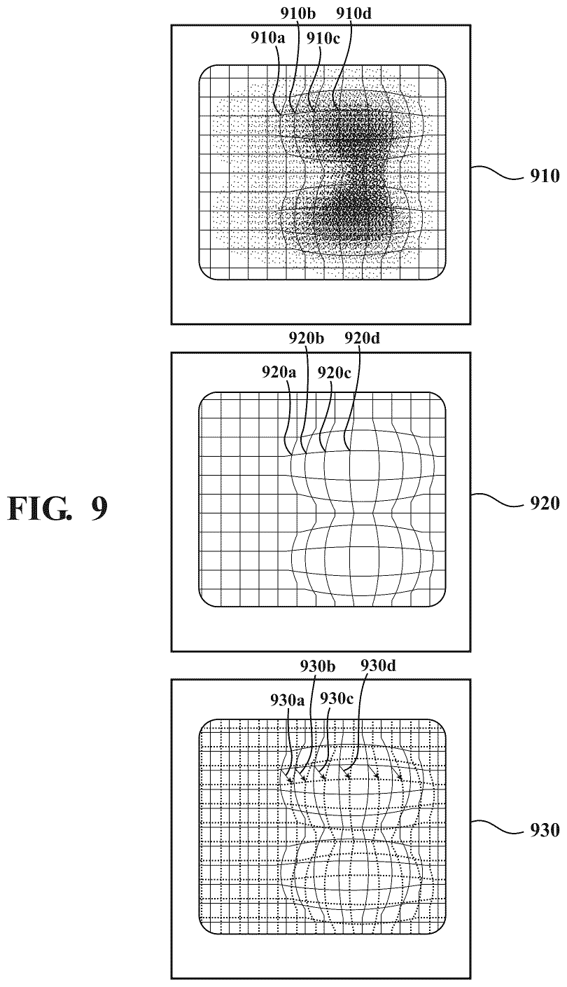

In some embodiments, command module 230 may receive a pair of point-clouds at two different times. Based on a comparison of the point-clouds, command module 230 may generate a force map. For example, as shown in FIG. 9, command module 230 may track one or more specific points (e.g., 910a-n) in point-cloud 910 and compare them to one or more corresponding points (e.g., 920a-n) in point-cloud 920 (e.g., based on seat pattern 340), then generate one or more vectors (e.g., 930a-n) demonstrating the movement of each point from the first point-cloud to the second point-cloud (e.g., 910a to 920a, . . . , 910n to 920n) to generate force map 930. In some embodiments, command module 230 may scale each vector depending on the time between the first point-cloud and the second point-cloud.

Based on one or more depth maps, one or more point-clouds, one or more force maps, or a combination thereof, command module 230 may generate indicators estimating the nature or movement of an object residing on seat material 330. For example, command module 230 may evaluate one or more depth maps, one or more point-clouds, one or more force maps, or a combination thereof to create a deformation pattern indicating the estimated shape of an object residing on seat material 330. In some embodiments, command module 230 may utilize machine learning to construct a deformation pattern based on one or more depth maps, one or more point-clouds, one or more force maps, or a combination thereof.

In some embodiments, command module 230 may evaluate deformation patterns to predict the identity of a vehicle occupant. For example, when a vehicle occupant sits in vehicle 100 for the first time, command module 230 may capture the deformation pattern arising from the vehicle occupant's posterior and associate it with the vehicle occupant's identity (e.g., a heaver, wider posterior is associated with a first driver; a lighter, narrow posterior is associated with a second driver). In future situations, command module 230 may then compare a current deformation pattern with deformation patterns in vehicle occupant records to estimate the identity of the driver. If the estimate is above a pre-determined threshold (e.g., above 80%), command module 230 may make a determination as to the identity of a seat occupant, which may further include instructing vehicle 100 to adjust vehicle settings to preferences set by the vehicle occupant.

In some embodiments, the deformation pattern may substantially indicate that a seat occupant is not a valid vehicle operator. For example, the deformation pattern caused by a child sitting on seat may be compared with vehicle operator profiles or one or more pre-determined generic profiles to estimate whether the seat occupant is an adult. If the estimate is below a pre-determined threshold (e.g., below 60%), command module 230 may restrict operation of vehicle 100. As another example, a vehicle operator may instruct command module 230 to only allow operation of vehicle 100 if a deformation pattern sufficiently matches one stored in a vehicle occupant record.

In some embodiments, the deformation pattern may substantially indicate that a seat occupant is likely non-human. For example, the deformation patterns of boxes may substantially differ from that of deformation patterns caused by human occupants, such that command module 230 may estimate whether an object residing on seat material 330 is not a person. If the estimate is below a pre-determined threshold (e.g., below 40%), command module 230 may utilize such information in adjusting vehicle settings (e.g., disabling a seatbelt reminder system) or seeking additional information (e.g., requesting clarification of whether a child-seat has been placed on seat material 330). If a vehicle operator indicates that a child-seat has been installed, command module 230 may associate the deformation pattern arising from the child-seat with a vehicle occupant record, thereby allowing for command module 230 to estimate the presence of such a child seat in the future. If the estimate is above a pre-determined threshold (e.g., above 80%), command module 230 may issue a request to the vehicle operator to identify if the child seat is present and if confirmation is received, command module 230 may configure the vehicle in accordance with the presence of such a child seat (e.g., disabling airbags in the vicinity of the child seat). In some embodiments, the deformation pattern of a child seat may by further evaluated to determine if the child is present in the child seat or not. If such a status changes, command module 230 may issue an alert to a vehicle occupant (e.g., alerting a driver that a child has left his or her child seat). In some embodiments, once command module 230 receives sufficient indication that the child seat has been removed (e.g., the estimate falls below a threshold), command module 230 may again adjust vehicle settings (e.g., re-enabling air bags).

In some embodiments, command module 230 may analyze one or more force maps to determine if a high-risk situation is present. For example, if one or more forces recorded on a force map show a change above a threshold (e.g., greater than 10%) within a pre-determined time, command module 230 may determine that the seat occupant is in a high state of acceleration. In some embodiments, a determination that a seat occupant is in a high state of acceleration may cause command module 230 to prepare one or more safety mechanisms to avoid injury (e.g., engaging seatbelt pretensioners; deploy air bags). In some embodiments, if the determination that a seat occupant is in a high state of acceleration also includes a determination that the seat occupant is not a person, command module 230 may engage safety mechanisms to prevent distracted driving (e.g., engaging lane-keeping assistance). Such an embodiment may further require command module 230 detecting a shift in a vehicle operator's deformation pattern indicating distracted driving (e.g., a change in a deformation pattern indicates the vehicle operator has substantially shifted their balance toward a passenger seat or the rear vehicle seats).

In some embodiments, command module 230 may analyze deformation patterns or force maps to determine if a driver is fatigued. For example, a change toward a more relaxed posture (e.g., one arising from the driver falling asleep) may cause a substantial shift in a deformation pattern. If command module 230 detects a deformation pattern associated with a relaxed posture (e.g., because the estimate is above a pre-determined threshold), command module 230 may enable safety mechanisms, attempt to alert the driver, or both. If alerting the driver occurs and command module 230 determines that the driver remains impaired (e.g., because the deformation pattern has not changed; because no forces in a force map exceed a pre-determined threshold), command module 230 may enable safety mechanisms to safely stop the vehicle (e.g., slowing down and stopping on a shoulder, then notifying authorities of a need for assistance). Similarly, command module 230 may also analyze deformation patterns or force maps to determine whether a driver is over-excited, such that command module 230 should similarly enable safety mechanisms.

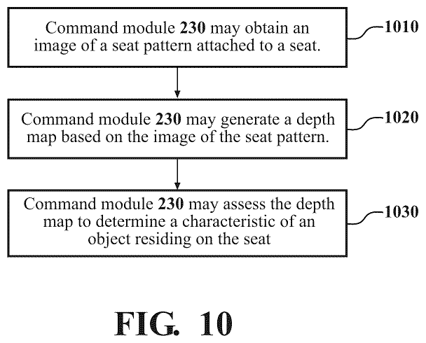

FIG. 10 illustrates a flowchart of a method 1000 that is associated with using seat force tracking strategies. Method 1000 will be discussed from the perspective of the vehicle seat force tracking system 170 of FIGS. 1 and 2. While method 1000 is discussed in combination with the vehicle seat force tracking system 170, it should be appreciated that the method 1000 is not limited to being implemented within vehicle seat force tracking system 170 but is instead one example of a system that may implement method 1000.

At step 1010, command module 230 may obtain an image of a seat pattern attached to a seat. For example, a monocular camera positioned below a seat may observe a seat pattern attached to a deformable material making up the bottom of a vehicle seat. As forces are imposed upon or removed from the vehicle seat by an object residing on the seat, such forces may cause the seat pattern to deform while being observed by the monocular camera.

At step 1020, command module 230 may generate a depth map based on the image of the seat pattern. For example, using the camera pinhole method and information regarding camera intrinsics, an image captured by a monocular camera may be converted into a depth map.

At step 1030, command module 230 may assess the depth map to determine a characteristic of an object residing on the seat. For example, based on the depth map or a point-cloud or force map derived from the depth map, command module 230 may determine whether the object is a person or not, whether the person is impaired, or other aspects regarding the object (e.g., it being in a state of high acceleration.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, vehicle seat force tracking system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, vehicle seat force tracking system 170, automated driving module(s) 160, or any combination thereof may control some or all of these vehicle system(s) 140 and, thus, may be partially or fully autonomous.

Processor(s) 110, vehicle seat force tracking system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, vehicle seat force tracking system 170, automated driving module(s) 160, or any combination thereof may control the direction, speed, or both of vehicle 100. Processor(s) 110, vehicle seat force tracking system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with vehicle seat force tracking system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™M, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
obtain an image of a seat pattern attached to a seat;
generate a depth map based on the image of the seat pattern; and
assess the depth map to determine a characteristic of an object residing on the seat.

2. The system of claim 1, wherein the machine-readable instructions to assess the depth map to determine the characteristic of the object residing on the seat further includes assessing whether the object is a person.

3. The system of claim 1, wherein the machine-readable instructions to assess the depth map to determine the characteristic of the object residing on the seat further includes assessing whether the object is associated with a deformation pattern.

4. The system of claim 1, wherein the machine-readable instructions to assess the depth map to determine the characteristic of the object residing on the seat further includes generating a first point cloud based on the depth map.

5. The system of claim 4, wherein the machine-readable instructions to assess the depth map to determine the characteristic of the object residing on the seat further includes receiving a second point cloud and generating a force map based on a comparison of features between the first point cloud and second point cloud.

6. The system of claim 5, wherein the machine-readable instructions that, when executed by the processor, further includes causing the processor to:
evaluate the force map to determine if a vehicle occupant is in a high state of acceleration.

7. The system of claim 5, wherein the machine-readable instructions that, when executed by the processor, further includes causing the processor to:
evaluate the force map to determine if a vehicle occupant is impaired.

8. A non-transitory computer-readable medium including instructions that when executed by one or more processors cause the one or more processors to:
obtain an image of a seat pattern attached to a seat;
generate a depth map based on the image of the seat pattern; and
assess the depth map to determine a characteristic of an object residing on the seat.

9. The non-transitory computer-readable medium of claim 8, wherein the instructions to assess the depth map to determine the characteristic of the object residing on the seat further includes assessing whether the object is a person.

10. The non-transitory computer-readable medium of claim 8, wherein the instructions to assess the depth map to determine the characteristic of the object residing on the seat further includes assessing whether the object is associated with a deformation pattern.

11. The non-transitory computer-readable medium of claim 8, wherein the instructions to assess the depth map to determine the characteristic of the object residing on the seat further includes generating a first point cloud based on the depth map.

12. The non-transitory computer-readable medium of claim 11, wherein the instructions to assess the depth map to determine the characteristic of the object residing on the seat further includes receiving a second point cloud and generating a force map based on a comparison of features between the first point cloud and second point cloud.

13. The non-transitory computer-readable medium of claim 12, wherein the instructions further include to:
evaluate the force map to determine if a vehicle occupant is in a high state of acceleration.

14. A method, comprising:
obtaining an image of a seat pattern attached to a seat;
generating a depth map based on the image of the seat pattern; and
assessing the depth map to determine a characteristic of an object residing on the seat.

15. The method of claim 14, wherein the step of assessing the depth map to determine the characteristic of the object residing on the seat further includes assessing whether the object is a person.

16. The method of claim 14, wherein the step of assessing the depth map to determine the characteristic of the object residing on the seat further includes assessing whether the object is associated with a deformation pattern.

17. The method of claim 14, wherein the step of assessing the depth map to determine the characteristic of the object residing on the seat further includes generating a first point cloud based on the depth map.

18. The method of claim 17, wherein the step of assessing the depth map to determine the characteristic of the object residing on the seat further includes:
receiving a second point cloud;
and generating a force map based on a comparison of features between the first point cloud and second point cloud.

19. The method of claim 18, further comprising:
evaluating the force map to determine if a vehicle occupant is in a high state of acceleration.

20. The method of claim 18, further comprising:
evaluating the force map to determine if a vehicle occupant is impaired.
